(19) United States
(12) Patent Application Publication
(10) Pub. No.: US 2004/0202004 A1
(43) Pub. Date: Oct. 14, 2004

(54) Bifunctional headlamp having a rotating shield with integral actuator

(75) Inventor: Paul D. Van Duyn, Anderson, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, A Delaware Corporation, Pendleton, IN (US)

(21) Appl. No.: 10/409,720

(22) Filed: Apr. 9, 2003

(51) Int. Cl. F21V 17/02; F21V 1/10

(52) U.S. Cl. 362/512; 362/280; 362/324; 362/361

(57) ABSTRACT

A bifunctional headlamp having a bulb shield operable to project a low beam light pattern or a high beam light pattern. A bulb shield surrounds a bulb inside a housing. The bulb shield is attached to an actuator, which rotates the bulb shield about the bulb. The bulb shield contains projections placed opposite one another on the bulb shield, which serve to selectively shield portions of emitted light from the bulb from reflecting out of the housing. The selective shielding of the light emitted from the housing allows the bifunctional headlamp to utilize one bulb for both a low beam pattern and a high beam pattern. The use of one bulb for two functions reduces complexity and electrical requirements.

### BACKGROUND

Automobiles are required to include headlamps which include both low beam and high beam light patterns for low-light driving. A low beam pattern projects light from the headlamp downwardly, onto a road surface. The low beam pattern is specifically arranged to project a minimum of light into oncoming traffic, and is designed for general use when other automobiles may be nearby. A high beam pattern is typically used in conjunction with the low beam pattern, and projects light further onto the road, illuminating surrounding areas of the road surface, both of which allows the automobile driver an enhanced field of view over the low beam pattern. The high beam pattern is not used in situations where other automobiles are on the road ahead, as the high beam pattern projects light into oncoming traffic, which creates an unsafe driving condition. Thus, the automobile driver may utilize the high beam pattern to increase safety on an unused area of roadway, and the low beam pattern when negotiating oncoming traffic or following another automobile.

Manufacturers may provide low beam and high beam patterns by utilizing separate headlamp assemblies and/or reflectors to project each. In this instance, a low beam headlamp/reflector is energized to provide a low beam pattern. When high beam functionality is desired, a high beam headlamp/reflector is energized, in addition to the low beam headlamp, to provide the additional high beam pattern.

Further, a manufacturer may provide two bulbs with one reflector in a headlamp assembly with one bulb oriented to provide a low beam pattern, and a second bulb oriented to provide a high beam pattern. The bulb which produces the high beam pattern may thus be selectively energized to provide high beam functionality.

In the above examples, two bulbs are required to provide low and high beam patterns for one side of the automobile. The use of the high beam doubles the electrical requirements of the headlamp lighting system, which places an additional burden on the automobile's electrical system. Additionally, the use of two bulbs requires the use of additional electrical wiring and mechanical attachments, which increases the complexity of the headlamp assembly.

A desirable feature of a headlamp would be a mechanism to allow a single bulb to provide both a low beam pattern and a high beam pattern. A single bulb reduces the overall electrical demands of the automobile, which serves to increase efficiency. A single bulb also allows for a smaller, less complex, and more compact footprint of the headlamps on the front of the automobile. A smaller headlamp footprint may be useful in itself, to allow automobile manufacturers a greater ability to add stylization to the front of the automobile, which in turn may attract consumer interest.

### SUMMARY

A bifunctional headlamp comprises a housing and a frame attached to the housing. A lamp is positioned within the housing. A reflector is formed on the inside surface of the housing. Attached therein to the frame is an actuator. The actuator operates an actuator shaft, integral with and extending from the actuator. The actuator may be comprised of an electric motor or a rotary solenoid, operable to rotate the actuator shaft, such that rotation of the actuator shaft results in rotation of the bulb shield about the bulb. The electric motor may optionally be a stepper-type electric motor, capable of operating on the actuator shaft to rotate the actuator shaft in discrete rotational increments. The actuator shaft is in communication with a bulb shield. The bulb shield is essentially cylindrical, and comprises two projections arranged on the bulb shield 180 degrees apart. The two projections may be semi-circular, or may be of a shape necessary to create a desired light pattern on the reflector surface. The bulb shield partially surrounds the bulb, and contains a central axis, which intercepts the bulb. Rotation of the actuator shaft results in rotation of the bulb shield about the bulb. While rotating, the central axis of the bulb shield remains intercepted with the bulb. Rotation of the bulb shield reorients the bulb shield with respect to the bulb. The reorientation changes the position of the semi-circular projections, and selectively blocks light from the bulb from striking the reflector. The selective blocking of light emitted from the bulb allows two patterns of light to be emitted from the headlamp; a first pattern for low beam light emission, and a second pattern for high beam light emission. In this way, a single bulb may be utilized to project both low beam and high beam patterns from the headlamp.

### BRIEF DESCRIPTION OF THE DRAWINGS

FIG. 1 is a side view of a bifunctional headlamp;

FIG. 2A is a top cross sectional view of the bifunctional headlamp along the line A-A of FIG. 1, projecting light in a low beam pattern;

FIG. 2B is a top cross sectional view of the bifunctional headlamp along the line A-A of FIG. 1, projecting light in a high beam pattern;

FIG. 3A is a rear perspective component view of the bulb shield of FIG. 1;

FIG. 3B is a side perspective component view of the bulb shield of FIG. 1;

FIG. 4A is a top component view of the bulb shield and the bulb along line D-D of FIG. 1;

FIG. 4B is a view of FIG. 4A, with the bulb shield rotated ninety degrees clockwise about the bulb; and

FIG. 5 is a front view of the reflector of a bifunctional headlamp along the line B-B of FIG. 1.

### DETAILED DESCRIPTION

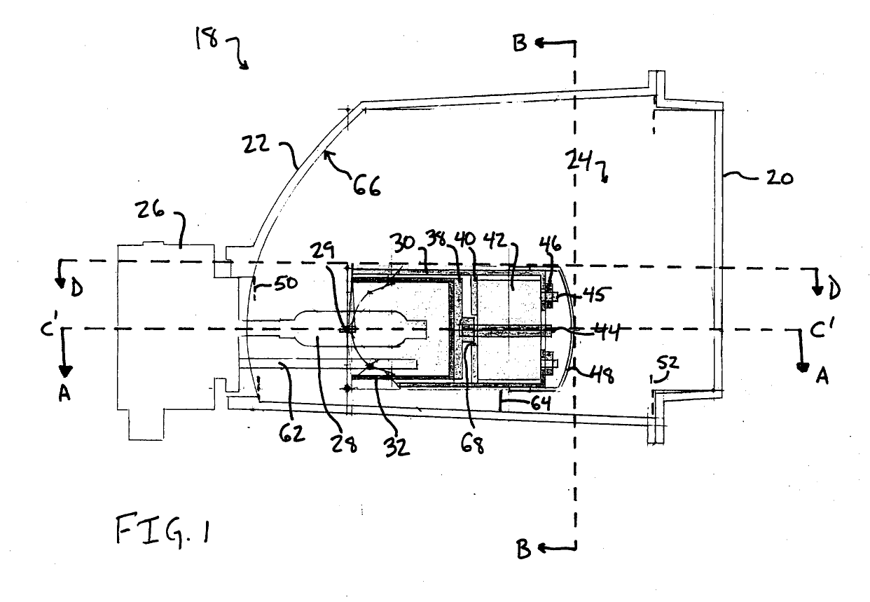

One embodiment of a bifunctional headlamp containing a rotating shield with integral actuator is provided as shown in FIG. 1, and is generally indicated as numeral 18. The bifunctional headlamp 18 comprises a bulb 28 positioned within a housing 22. A bulb shield 32 is positioned about the bulb 28. A shield support 38 is attached to the bulb shield 32, and the shield support 38 is attached to an actuator shaft 44. An actuator 42 is operable on an actuator shaft 44 to rotate the bulb shield 32 about the bulb 28. Rotation of the bulb shield 32 about the bulb 28 serves to vary the light pattern emitted from the bifunctional headlamp 18 from a low beam pattern to a high beam pattern.

The outside of the bifunctional headlamp 18 is formed from the housing 22 and a lens 20. The housing 22 contains a first housing opening 50 and a second housing opening 52. The first housing opening 50 is dimensioned to receive a standard electrical socket 26 and bulb 28 for headlamps. The second housing opening 52 is a comparable diameter to the lens 20. The walls of the housing 22 at the second housing opening 52 and the lens 20 abut one another, and are sealed together. The seal may be accomplished in one of a number of ways known in the art. The union of the housing 22 and the lens 20 defines a cavity 24 where the bulb is positioned. The lens 20 is manufactured from a transparent material, and may optionally have optics integrated into the lens 20, which serve to focus or angle emitted light rays. The lens 20 may optionally be made from a material which allows light of a certain wavelength or range of wavelengths to pass, therefore imparting a distinct color to light radiated outside of the bifunctional headlamp 18. A reflector 66 is formed on the inside surface of the housing 22. The reflector 66 faces the cavity 24, and is formed by coating a portion of the inside housing 22 with a material which reflects light rays. Techniques for coating the inside surface of the housing 22 with a reflective material, or optionally for forming the housing 22 out of a reflective material, are well known in the art. Of course, the reflector 66 may need not be formed as part of the housing, and may be provided as separate from the housing and positioned within the housing.

The bulb 28 plugs into a standard electrical socket 26. The electrical socket 26 is releasably attached to the housing 22 at the first housing opening 50. When the electrical socket 26 is attached to the housing 22, the bulb 28 enters the cavity 24 through the first housing opening 50. The electrical socket 26 provides an electrical attachment point to the automobile's electrical system. The concept of an electrical socket 26 and bulb 28 is well understood and practiced in the art. Of course, the bulb 28 may be any of the headlamp bulbs known in the art, for example, incandescent, halogen, high-intensity gas discharge, or one or more light-emitting diodes.

The frame 30 is essentially cylindrical with one or more leg portions 64 extending therefrom. The frame legs 64 are attached to the housing 22 by welding or other means known in the art, such that the frame 30 extends into the cavity 24 created by the union of the housing 22 and the lens 20, and partially surrounds the bulb 28. The frame 30 is made from a rigid material, and is used as an attachment point for components within the cavity 24.

Opposite the side of the actuator 42 which contains the plurality of actuator retaining posts 45, the actuator 42 abuts an actuator support 40. The actuator support 40 is fixed to the inside of the frame 30, and further prevents movement of the actuator 42 along the C′ axis. The actuator support 40 is essentially circular, and is of a similar diameter to the inner diameter of the frame 30. An opening 68 is located in the center of the actuator support 40, which is of a greater diameter than the diameter of the actuator shaft 44. The actuator shaft 44 extends through the opening 68 in the actuator support 40 such that the actuator support 40 and the actuator shaft 44 are concentric. In one embodiment, the actuator support 40 may alternately be fixed to the actuator 42 and designed and dimensioned to fit snugly within the frame 30 to assure proper installation and orientation of the actuator 42 into the frame 30.

The actuator 42 is attached to the frame 30. In the disclosed embodiment, the actuator comprises an electric motor comprising an actuator shaft 44. However, the actuator may be any of several devices such as a rotary solenoid operable to rotate an integrated shaft, or a linear solenoid connected to a rotating drive mechanism. In one embodiment, the actuator 42 may be a “stepper” type motor, which operates on the actuator shaft 44 to rotate the actuator shaft 44 to discrete angular positions, particularly, ninety degrees of rotation. The actuator 42 may be essentially cylindrical, and the outer diameter of the actuator 42 is of a similar diameter to the inner diameter of the frame 30. The rear of the actuator 42 contains one or more actuator retaining posts 45, which extend through openings in the frame 30. One or more actuator fasteners 46 secure the extensions of the one or more actuator retaining posts 45. The actuator 42 is connected to electrical leads (not shown), which distribute electricity from the automobile's electrical system to the actuator 42, through a headlamp control system (not shown). The actuator 42 operates, upon the application of an electric current, to rotate an actuator shaft 44 about the C′ axis.

The shield support 38 is essentially circular, and is of a smaller diameter than the inner diameter of the frame 30,. The shield support 38 is attached to the end of the actuator shaft 44 which extends through the actuator support 40, such that rotation of the actuator shaft 44 results in an equal amount of rotation of the shield support 38. The shield support 38 provides a secure attachment point for the bulb shield 32 to the actuator shaft 44, and also serves as the primary insulator of the actuator 42, to shield the actuator 42 from thermal energy produced by the bulb 28. The actuator support 40 functions as a secondary actuator 42 insulation device.

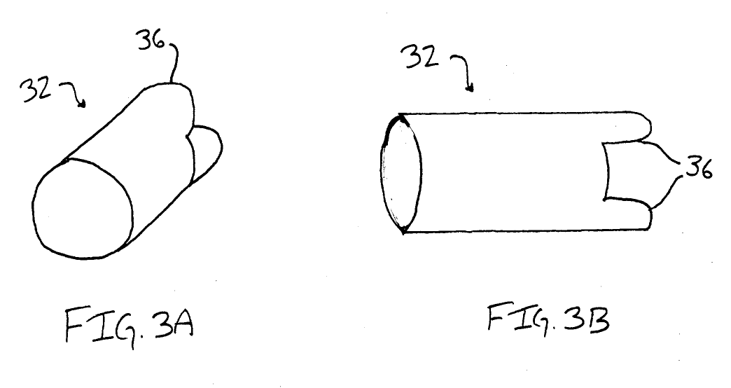

The bulb shield 32 is attached to the shield support 38. As shown in FIGS. 3A and 3B, the bulb shield 32 is essentially cylindrical, and the outer diameter of the bulb shield 32 is smaller than the inner diameter of the frame 30. Referring again to FIG. 1, the bulb shield 32 is positioned around the bulb 28 such that the central axis of the bulb shield 32 intercepts the bulb 28. The bulb shield 32 contains two roughly semi-circular projections 36, formed on one end of the bulb shield 32 and 180 degrees opposite one another, which extend into the cavity 24. The projections 36 are positioned about the bulb 28, such that the projections 36 shield the bulb 28 from projecting light onto certain portions of the reflector 66. In an alternate embodiment of the present invention, the bulb shield 32 is essentially cylindrical, and contains projections 36 which are arranged asymmetrically about the bulb shield 32. In the alternate embodiment, the projections 36 may have different individual shapes, so that an asymmetric beam pattern may be emitted from the lamp assembly 18.

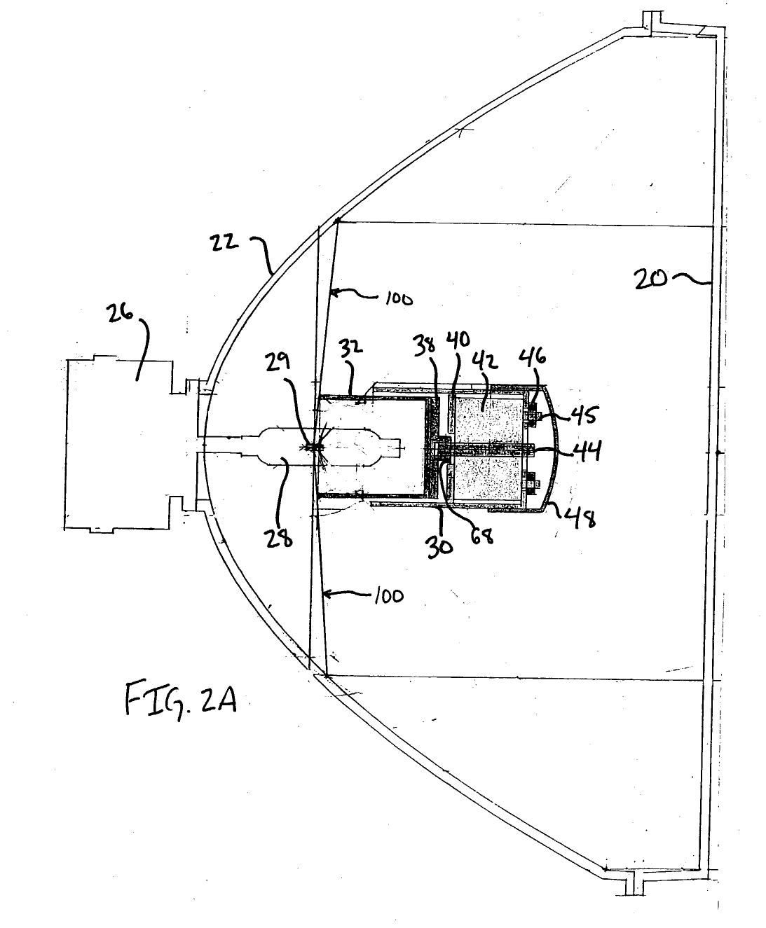

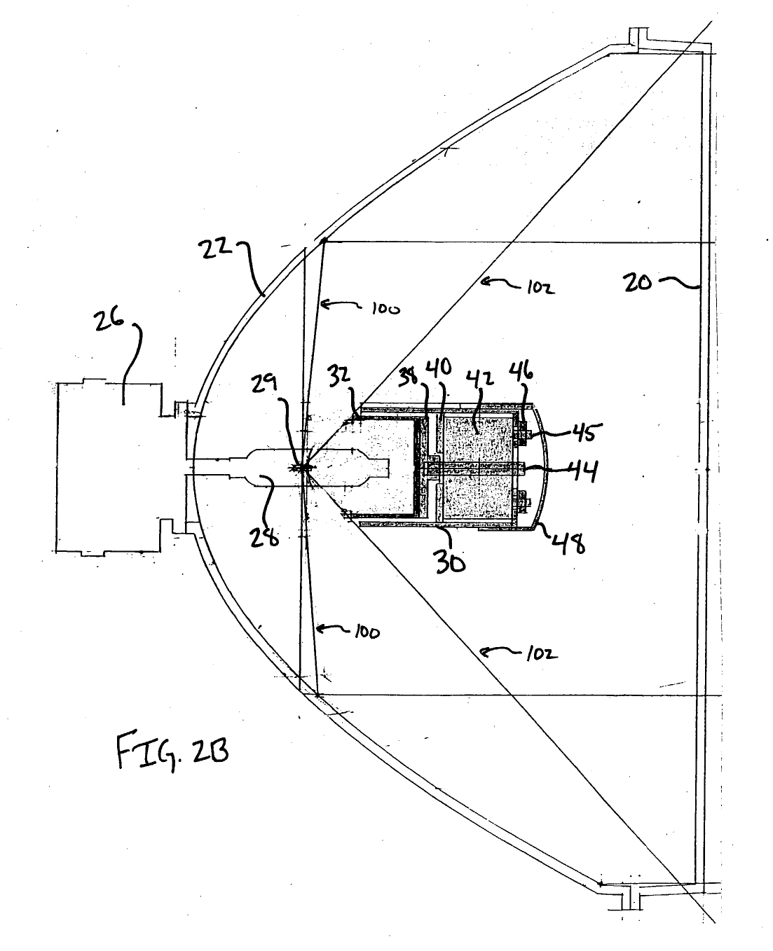

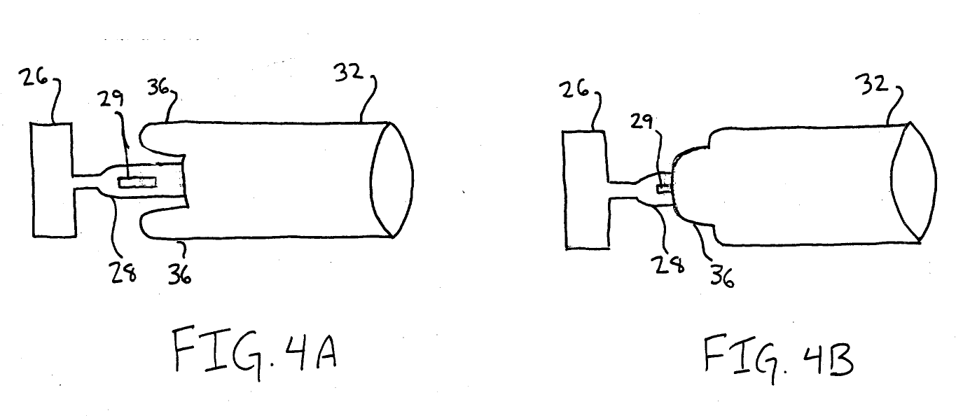

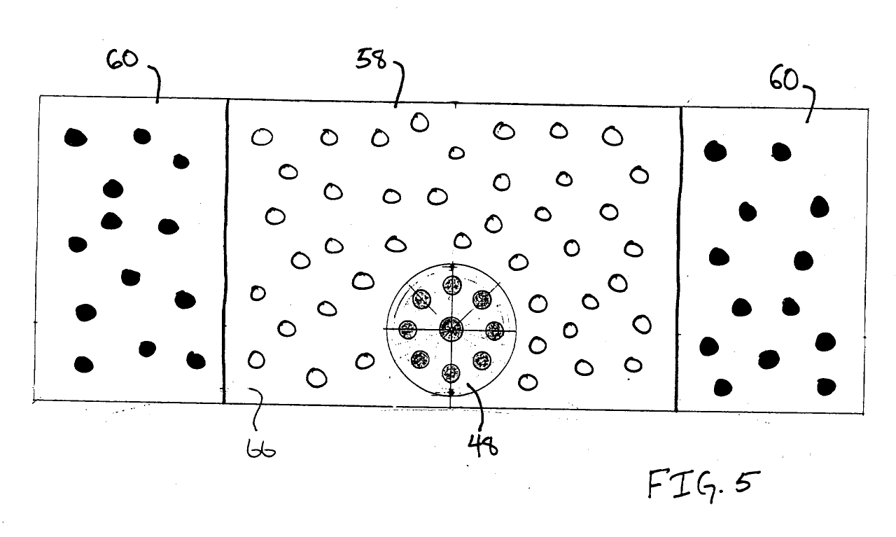

FIG. 4A shows a top component view of the bulb shield 32 and the bulb 28 along the D-D line of FIG. 1 (i.e., the bulb shield and bulb from FIG. 2A). As shown in FIG. 4A, the projections 36 are positioned along the sides of the bulb 28. FIG. 4B shows the bulb shield 32 and the bulb 28 of FIG. 4A, with the bulb shield 32 rotated ninety degrees about the X axis shown in FIG. 4B (i.e., the bulb shield and bulb from FIG. 2B). The bulb shield 32 of FIG. 4B shows the bulb shield 32 with the projections 36 positioned along the top and bottom with respect to the bifunctional headlamp 18. FIGS. 4A and 4B show the bulb 28 positioned along the cylindrical axis of the bulb shield 32. As shown in FIG. 4A, the point source of light 29 of the bifunctional headlamp 18 is fully viewable between projections 36 from the top view. As shown in FIG. 4B, with the bulb shield 32 rotated ninety degrees, the top view results in the point source of light 29 of the bulb 28 being partially covered by the bulb shield 32 (i.e. obstructed from view by one of the projections 36 of the bulb shield 32). The point source of light may comprise any number of different light sources, including the filament of an incandescent bulb, the electric arc of a high intensity discharge bulb, or from the diode of a light emitting diode, depending on the type of bulb used. It should be noted that since the two projections 36 are opposite one another, a 180 degree rotation of the bulb shield 32 about the bulb 28 as shown in FIG. 4A yields the same view as in FIG. 4A, and a 270 degree rotation of the bulb shield 32 about the bulb 28 as shown in FIG. 4A yields the view of FIG. 4B. Thus, a ninety degree rotation of the bulb shield 32 about the bulb 28, in either the clockwise or counterclockwise direction, yields alternating views of the bulb 28 and the bulb shield 32 exemplified by FIGS. 4A and 4B. In an alternate embodiment which includes a bulb shield 32 having asymmetrical projections 36, as described above, the bulb shield 32 may not be rotated in ninety degree increments, but may occur over another discrete angle. Also, an asymmetrical projection 36 arrangement for a bulb shield 32 may require that the actuator shaft 44 rotate the bulb shield 32 both clockwise and counterclockwise to change the shielding pattern about the bulb 28.

Referring again to FIG. 1, an insulated electrical lead 62 is attached to the electrical interface. The insulated electrical lead 62 carries electricity from the automobile's electrical system to the lamp 78. The insulated electrical lead 62 is utilized to transfer electricity to the lamp assembly in the event a high intensity discharge bulb is used.

A decorative cap 48 is attached to the frame 30. The decorative cap 48 obscures the upper section of the frame 30 and components located within and/or upon the frame 30 from outside view.

A headlamp control system (not shown) is in electrical communication with the actuator 42. The headlamp control system (not shown) may be a microprocessor or another controller, which receives input from various sensors or switches, such as dashboard switches under human operation. The headlamp control system (not shown) controls the duration and rotational direction of actuator shaft 44 rotation by selectively applying an electric current to the electrical leads (not shown) which are connected to the actuator 42.

Operation of the disclosed embodiment of the bifunctional headlamp 18 containing a rotating shield with integral actuator is now described with reference to FIG. 1. The headlamp control system determines when electric current is provided to the actuator 42. The application of an electric current to the actuator 42 causes the actuator 42 to operate on the actuator shaft 44, rotating the actuator shaft 44 for a specific duration and in a specific rotational direction as communicated by the headlamp control system. In particular, the application of electric current to the actuator 42 causes the actuator shaft 44 to rotate ninety degrees clockwise from a low beam position, and into a high beam position. It should be appreciated that if the bulb shield 32 is symmetrical, and the projections 36 of the bulb shield 32 are opposite one another, a ninety degree rotation either clockwise or counterclockwise will accomplish the same effect. Thus, if the first position of the bulb shield 32 was such that the projections 36 were vertically aligned with respect to the bifunctional headlamp 18, then a ninety degree rotation of the bulb shield 32 clockwise or counterclockwise would reorient the bulb shield 32 such that the projections 36 were horizontally aligned with respect to the bifunctional headlamp 18. Of course, if the projections 36 of the bulb shield 32 are arranged asymmetrically, rotation of the bulb shield 32 over an angle other than ninety degrees may be employed to rotate the bulb shield 32 between a high beam position and a low beam position. Also, if the bulb shield projections 36 are arranged asymmetrically about the bulb shield 32, the actuator 42 may be employed to rotate the bulb shield 32 in both a clockwise and counterclockwise fashion, to rotate the bulb shield 32 between a high beam position and a low beam position..

Movement of the actuator shaft 44 translates into movement of the shield support 38 and movement of the bulb shield 32. The bulb shield 32, as described above, rotates about the bulb 28. In the low beam position, the projections 36 of the bulb shield 32 are aligned along the sides of the bulb 28 and block light rays that contribute to a high beam pattern from striking the reflector 66. At the same time, the bulb shield allows light rays that contribute to a low beam pattern to strike the reflector 66 and emit a low beam from the headlamp 18. In the high beam position, the projections 36 of the bulb shield are aligned along the top and bottom of the bulb and the bulb shield allows light rays that contribute to both the high beam and low beam pattern to strike the reflector 66 and emit a high beam from the headlamp.

FIG. 2A is a top cross sectional view of the bifunctional headlamp 18 along the line A-A of FIG. 1, showing the position of the bulb shield allowing light to be projected in a low beam pattern. In FIG. 2A, light rays 100 that contribute to a low beam pattern strike the reflector 66 and are emitted from the bifunctional headlamp 18. Other light rays, specifically those that contribute to a high beam pattern, are blocked by the projections 36 of the bulb shield 32. Thus, if the projections 36 aligned horizontally with respect to the bifunctional headlamp 18, the bulb shield 32 allows only low beam light rays to emit from the bifunctional headlamp 18.

FIG. 2B is a top cross sectional view of the bifunctional headlamp 18 along the line A-A of FIG. 1, showing the position of the bulb shield allowing light to be projected in a high beam pattern. In FIG. 2B, light rays that contribute to both a high beam 102 and a low beam 100 strike the reflector 66 and are emitted from the bifunctional headlamp 18. In the high beam position, the projections of the bulb shield 32 are positioned above and below the bulb, allowing both the high beam light rays 102 and the low beam light rays 100 to strike the reflector 66 and emit light from the headlamp 18.

Referring now to FIG. 5, a front view of the reflector is shown. The decorative cap 48 is shown in FIG. 5 with the reflector 66 positioned in the background. A first portion 58 of the reflector 66 is identified by a plurality of open circles. This first portion 58 is the portion of the reflector used to provide the low beam pattern for the headlamp. A second portion 60 of the reflector 66 is provided adjacent and peripheral to the first portion 58. The second portion 60 of the reflector 66 is identified by closed circles in FIG. 5. This second portion 60 of the reflector 66 is used in conjunction with the first portion 58 to provide the high beam pattern for the headlamp. When the bulb shield 32 is in the low beam position, the projections 36 of the bulb shield 32 block light from striking the second portion 60 of the reflector, and light is only permitted to strike the first portion 58 of the reflector. When the bulb shield is in the high beam position, light is allowed to strike both the first portion 58 and second portion 60 of the reflector 66.

As can be readily seen, the present invention of varying the light pattern of emitted light between a low beam pattern and a high beam pattern creates the ability for one bulb to serve dual purposes. Utilizing the present invention as a headlamp in an automobile serves to decrease the size and weight of the headlamp, by allowing for the reduction in the total number of bulbs and associated components inside the headlamp. In addition, the arrangement provides for significant savings over headlamp arrangements with multiple reflectors and bulbs used to provide high beam and low beam functions.

Although other advantages may be found and realized and various modifications may be suggested by those versed in the art, it is understood that the present invention is not to be limited to the details given above, but rather may be modified within the scope of the appended claims. For example, the lamp shield position and the reflector orientation, and thus the low beam and high beam patterns, are not limited to positions as described above. The lamp shield and/or the reflector may be positioned such that the low beam and high beam positions remain at right angles, but the entire lamp projection axis may be oriented at an angle or perhaps vertically. Also, the reflector may be able to tilt, thus rendering the reflector independently aimable. In this embodiment, the frame and the components attached therein may tilt with the aimable reflector.

I claim:

1. A bifunctional headlamp comprising:
a. a housing;
b. a bulb positioned within the housing;
c. a bulb shield partially surrounding the bulb, the bulb shield having a central axis that intercepts the bulb; and
d. an actuator in communication with the bulb shield and operable to rotate the bulb shield about the bulb such that the bulb shield central axis remains intercepted with the bulb.

2. A bifunctional headlamp as in claim 1, further comprising a reflector arranged and disposed in the housing to reflect light emitted from the bulb out of the housing.

3. A bifunctional headlamp as in claim 1, where the bulb shield is essentially cylindrical, and further comprises two essentially semi-circular projections arranged essentially 180 degrees apart on the bulb shield.

4. A bifunctional headlamp as in claim 1, where the bulb shield is essentially cylindrical, and further comprises two projections arranged asymmetrically about the bulb shield.

5. A bifunctional headlamp as in claim 1, where rotation of the bulb shield about the bulb results in the selective blocking of light onto specific portions of the reflector, resulting in a high beam or a low beam pattern.

6. A bifunctional headlamp as in claim 1, where the actuator is attached to a frame, which is attached to the housing.

7. A bifunctional headlamp as in claim 1, where the actuator is further comprised of an electric motor operable to rotate an actuator drive shaft that is in communication with the bulb shield.

8. A bifunctional headlamp as in claim 3, further comprising a decorative cap attached to the frame.

9. A bifunctional headlamp comprising:
a. a housing;
b. a reflector arranged and disposed in the housing to reflect light emitted from the bulb out of the housing;
c. a bulb arranged and disposed within the housing;
d. a bulb shield surrounding the bulb, the bulb shield having a central axis that intercepts the bulb; and
e. an actuator in communication with the bulb shield and operable to rotate the bulb shield about the bulb.

10. A bifunctional headlamp as in claim 9, where the bulb shield is essentially cylindrical, and further comprises two semi-circular projections arranged 180 degrees apart on the bulb shield.

11. A bifunctional headlamp as in claim 9, where rotation of the bulb shield about the bulb results in the selective blocking of light onto specific portions of the reflector, resulting in a high beam or a low beam pattern.

12. A method of varying the amount of light emitted from a headlamp comprising the steps of:
a. providing a housing, a bulb positioned within the housing, a bulb shield surrounding the bulb, the bulb shield having a central axis that intercepts the bulb, and an actuator used to rotate the bulb shield, maintaining the interception of the bulb shield central axis with the bulb;
b. energizing the bulb such that a beam of light is emitted from the housing; and
c. rotating the bulb shield about the bulb such that the beam of light emitted from the bifunctional headlamp is variable between a low beam pattern and a high beam pattern.

13. An apparatus for varying the amount of light emitted from a headlamp comprising:
a. a housing,
b. a bulb positioned within the housing,
c. a bulb shield surrounding the bulb, the bulb shield having a central axis that intercepts the bulb, and the bulb shield operable to rotate while maintaining the interception of the bulb shield central axis with the bulb; and
d. a means for rotating the bulb shield about the bulb such that the beam of light emitted from the bifunctional headlamp is variable between a low beam pattern and a high beam pattern.

14. An apparatus as in claim 13, where the means for rotating the bulb shield comprises an actuator with an actuator shaft, the actuator operable on the actuator shaft to rotate the bulb shield about the bulb.

15. A bifunctional headlamp comprising:
a. a bulb for emitting light;
b. a reflector positioned to reflect light emitted from the bulb into a beam of light having both a high beam pattern and a low beam pattern; and
c. a moveable bulb shield arranged axially about the bulb, operable to selectively restrict the high beam pattern from reflecting on the reflector.

16. A bifunctional headlamp as in claim 15, where the bulb shield is essentially cylindrical, and further comprises two essentially semi-circular projections arranged essentially 180 degrees apart on the bulb shield.

17. A bifunctional headlamp as in claim 15, where the bulb shield is essentially cylindrical, and further comprises two projections arranged asymmetrically about the bulb shield.

18. A bifunctional headlamp as in claim 15, where rotation of the bulb shield about the bulb results in the selective blocking of light onto specific portions of the reflector, resulting in a high beam or a low beam pattern.

19. A bifunctional headlamp as in claim 15, where the bulb shield is essentially cylindrical, and further comprises two semi-circular projections arranged 180 degrees apart on the bulb shield.

20. A bifunctional headlamp as in claim 15, where rotation of the bulb shield about the bulb results in the selective blocking of light onto specific portions of the reflector, resulting in a high beam or a low beam pattern.
